(19) United States
(12) Patent Application Publication
(10) Pub. No.: US 2007/0287820 A1
(43) Pub. Date: Dec. 13, 2007

(54) Binder and building material modified with vegetable oils and derivatives thereof

(76) Inventor: Harald Weirich, Uberherrn-Berus (DE)

Correspondence Address: K.F. ROSS P.C., 5683 RIVERDALE AVENUE, SUITE 203 BOX 900, BRONX, NY, 10471-0900, US

(21) Appl. No.: 11/805,561

(22) Filed: May 23, 2007

Related U.S. Application Data
(60) Provisional application No. 60/808,787, filed on May 26, 2006.

(30) Foreign Application Priority Data
May 26, 2006 (CH) 00867/06

(51) Int. Cl. C08G 83/00

(52) U.S. Cl. 528/1; 52/309.1

(57) ABSTRACT

The invention relates to a binder or building material on the basis of a synthetic material, like e.g. polystyrene in the form of a monopolymerisate or copolymerisate, or an inorganic polymer, which is available as an absorptive compound from the fragmented synthetic material or inorganic polymer and at least one vegetable oil, vegetable oil constituent or vegetable oil derivative. The binder or building material can be prepared by leaving the synthetic material or the inorganic polymer present in machined or fine-dispersed form to react with the vegetable oil, vegetable oil constituent, or vegetable oil derivative, and leaving the synthetic material or polymer thus modified to react with the identical or an additional vegetable oil, vegetable oil constituent, or vegetable oil derivative. The binder or building material can be used as an adhesive or sealant and as an additive to building materials, to manufacture an essentially homogeneous granulate of high flowability and bulk density, as a constituent of detergents and cleaning agents, and as a precursor or intermediate product for cosmetics and body-care products.

### CROSS-REFERENCE TO RELATED APPLICATIONS

This application claims the priority of Swiss patent application 00867/06 filed 26 May 2006 and is related to U.S. patent application No. 60/808,787 filed 26 May 2006.

### FIELD OF THE INVENTION

The present invention relates to binders. More particularly this invention concerns binders modified with vegetable oils and derivatives thereof and to a method to manufacture such binders and building materials as well as their preferred applications.

### BACKGROUND OF THE INVENTION

The starting point for the present invention are results which ensue from an invention, originate from the same applicant and were published as DE-B-41 19 193. DE-B-41 19 193 discloses an oil binding agent on the basis of a polystyrene foam and/or rigid polystyrene foam, in which the polystyrene foam is available in a fragmented, e.g. machined, form and coated with a vegetable oil. The vegetable oil moistens the surface of the polystyrene foam particles and thus considerably improves their properties. The basic idea in this regard was to provide an environmentally friendly product from a sustainable raw material, preferably even a waste product that occurs in vegetable oil manufacturing.

The binder thus obtained possesses an exceptional affinity to additional oil, regardless of its kind, and was therefore proposed as an agent to bind oil after oil spill accidents happening either in water or on land, to purify water, clean containers, or capture leakage oil. The solid polystyrene foam modified by the vegetable oil coverage then absorbs the additional oil like a piece of blotting paper.

In addition, owing to the vegetable oil coverage of the solid polystyrene foam, an astoundingly improved manageability of the binder ensued in the shape of a markedly higher bulk density and considerably improved flowability.

Prior art laboratory and demonstration experiments carried out by the applicant have also revealed that homogeneous black spherules measuring approximately 2-4 cm in diameter were created when applied to absorb crude oil, once the polystyrene foam particles had been loaded with vegetable oil and the crude oil had been most rapidly absorbed. These black spherules display an astonishing resistance to pressure and therefore, even under a distinctive pressure exertion, do not release the crude oil they have absorbed.

Initial results on the suitability as a binding agent, also reaching beyond the previously foreseen purpose of use as an oil-binding agent, obviously already ensue from the fact that the black spherules, astonishingly formed upon absorbing the crude oil when the polystyrene foam is coated with the vegetable oil at a certain rate, display a slight adhesiveness. The phenomenon which consisted in the mentioned black spherules being formed indicated the existence and/or the generation of strong ordering energies. Considerations from a completely different technical field were helpful to understand them.

A phenomenon is known in the context of phosphatizing metals which ensues from the use of lubricants based on soaps in conjunction with phosphate layers. If zinc phosphate layers on a work piece are converted with alkali soaps, zinc soap will be created which is particularly effective, on the one hand, and displays an ordered structure on the phosphate layer, on the other.

There seem to be ordering energies at work which can be utilized technically (see Dr. Rausch, “Die Phosphatierung von Metallen”, Eugen G. Lenze Verlag, Saulgau/Württ., second edition 1988).

It must be assumed that comparable ordering energies are also responsible for the phenomenon of the strong binding-effect of the vegetable oil coated, fragmented or machined synthetic foam coated such as the polystyrene (rigid) foam. Once having made this discovery, it was also at hand that the special properties of the synthetic material coated with vegetable oil, which had emerged during the absorption of crude oil, could be introduced to a number of further interesting applications.

### OBJECT OF THE INVENTION

Hence it is an aspect of the present invention to the introduce the synthetic foam, coated with vegetable oil and having become known to absorb crude oil, to further applications.

### SUMMARY OF THE INVENTION

This problem was solved by a binder or building material based on a synthetic material or an inorganic polymer, whereby the binder or the building material is available as an absorption compound from the fragmented synthetic material and at least one vegetable oil, a constituent of vegetable oil, or a derivative thereof, including further constituents or additives, if applicable.

In this regard, the concept of fragmentation must be defined widely. The particle size depends, apart from other factors, on the quality of the applied synthetic or polymer material, the desired purpose of use, and the applied fragmentation method. Material cutting or tearing techniques may be applied here, whereby the synthetic material or polymer is then either machined or brush-scraped. A granulate, with a grain size to be determined according to the purpose of use, may also serve as the initial material. In the scope of the invention here submitted, the concept of fragmented material also includes a granulate of any desirable grain size.

When either a machined or brush-scraped synthetic or polymer material is applied, particle sizes of less than approximately 3 mm, preferentially in a range between 1.5 and 0.5 mm, have proven to be reasonable.

If a granulate is applied, the grain size will depend on the type of the method chosen for manufacturing and the purpose of application as is customary to the expert.

As synthetic material, polystyrene can be applied in the shape of either a monopolymerisate or a copolymerisate. Polystyrene has the advantage of being inexpensive owing to the nature of its production, and of being available in a broad range of products as far as copolymerisates are concerned. A modified polystyrene can be equally or preferentially used for certain types of applications. A variety of such modified polystyrenes are known. α-methyl styrene may be mentioned as an example.

For certain application types, a polystyrene co-polymerisate is to be preferred as synthetic material which, for example, is selected from a styrene/(meth-)acrylate copolymer. This styrene/(meth-)acrylate copolymer, but also a monopolymerisate and/or another synthetic material, or polymer material, can be applied just as well in a fragmented form as a dispersion.

The vegetable oil, which serves for the formation of the absorption compound and thus for the formation of the binder or building material according to the invention, is preferentially selected from rape-seed oil (also referred to as colza oil, canbra oil or rape oil), sunflower-seed oil, soybean oil, castor oil, olive oil, linseed oil, coconut oil, palm oil, a constituent or derivative and mixtures thereof. However, it must be indicated at this point that this represents an exemplary enumeration of common vegetable oils, and that any vegetable oil may be applied to suit the purpose of the present invention.

The esters and glycine esters of the multiple unsaturated fatty acids are particularly to be pointed out as-the derivatives of the vegetable oil.

It is sufficiently known that the natural vegetable oils represent glycine esters of the higher even-numbered fatty acids, i.e. the glycerides, and are composed up to approximately 97% of triglycerides, up to approximately 3% of diglycerides and up to 1% of monoglycerides. Triglycerides, diglycerides and monoglycerides are composed of one molecule glycerin esterified with 3 molecules, 2 molecules, or 1 molecule of fatty acid, respectively. The chemical, physical and biological properties of the vegetable oils are determined by the nature of the fatty acid component and its distribution over the triglyceride molecules. It is also sufficiently known that the melting point generally increases with the increasing proportion of long-chain fatty acids and/or the decreasing proportion of short-chain or unsaturated fatty acids. The properties of a triglyceride are also determined by the position of the various fatty acid residues within the triglyceride molecule.

The fatty acids themselves are mainly even-numbered, unbranched aliphatic monocarbonic acids with chain lengths ranging from C₄ to C₂₄. The melting point of a fatty acid decreases with decreasing chain length and increasing number of the double bonds. Vegetable oils are liquid at room temperature due to their considerably large unsaturated fatty acid content.

If the respective vegetable oil is applied as an ester of the respective multiple-unsaturated fatty acid, the methyl esters will be of special interest. In this case, rape-seed fatty acid methyl esters, ricinoleic acid methyl esters, oleic acid methyl esters, linoleic acid methyl esters and lauric acid methyl esters have to be mentioned, whereby this enumeration is but exemplary. The possibilities are manifold and the selection as well as the further conversion of the vegetable oil, or any of its constituents, with additional fatty acids is possible to be achieved without difficulty by any person skilled in the art due to its common specialized knowledge.

The problem as mentioned at the beginning is also solved by the use of the binder or building material according to the invention as an adhesive or sealant. Here, adhesives and sealants of any kind and application are meant and to be included.

Starting out from the adhesive properties previously observed with regard to the spherical particles formed when binding crude oil, several tests were successfully performed which even confirmed the outstanding suitability of the binder according to the invention as an adhesive and sealant.

In principle, adhesives in their simplest composition consist of a binding agent to which a softening agent is added to improve their physical properties. Despite the fact that such softening agents are considered to be necessary for the applicability of the adhesives, the current state of technology is aware of various disadvantages associated with the use of such softening agents. One of the essential disadvantages, for example, consists in the decrease of the adhesive properties. The prescription to apply an adhesive only to clean, dry surfaces which are free of fat and oils, as is known from conventional adhesives, results but from this disadvantage.

It has also been long known and customary to use binders based on homopolymers or copolymers of styrene, or a modified polystyrene, as the basis of adhesives. In a preferred use, a modified polystyrene, preferably a α-methyl styrene, is applied according to the invention as a synthetic material.

A diverse range of styrene/(meth)acyrylate copolymers which are commercially available from BASF were drawn upon to manufacture the adhesive and sealant according to the invention. In this regard, Acronal of various specifications such as Acronal. 290D, Acronal S360D etc. is to be mentioned as the most essential and known product. Further representatives of the styrene copolymerisates available from BASF are, for example, Neocryl A 621 as a copolymer of styrene with an acrylic acid ester, Pliotec LS1 as a terpolymer of styrene, butyl acrylate and methacrylic acid, Rhodopas SB 012 as a copolymer of styrene with butadiene, or Synthomer VL 10286 as a terpolymer of styrene with butadiene and acrylonitrile.

As far as the vegetable oil component is concerned, which according to the invention serves as the softening agent, it is less preferable to apply the oil itself than a derivative thereof. Here, particularly the fatty acids and particularly their esters, most particularly their methyl esters, must be foremost mentioned, such as rape fatty acid methyl ester based on rape-seed oil (also briefly referred to as RHE), oleic acid methyl ester and linoleic acid methyl ester. The selection of the methyl ester(s) for the purpose of the respective application will depend, apart from other factors, upon economical considerations, i.e. which methyl ester(s) is/are available at a low price.

The proportion of the vegetable oil component in the adhesive or sealant according to the invention lies preferably between approximately 5 to 20%, most preferred between approximately 7 to 15%.

Furthermore, otherwise common additions known as such, for example, pigments can be added to the adhesive or sealant without exerting a negative influence on its effects.

Another preferred use of the binder and/or building material according to the invention relates to the building sector, i.e. specific product improvements of binding agents applied in the building sector, such as hydraulic binding agents, dry mortar products, gypsum and (non-hydraulic) lime. Hydraulic binders are understood as binding agents that harden both in air and in water and comprise cement, hydraulic lime, plaster and wall binders.

Here, tedious experiments have produced a number of astonishing product improvements, among which are an improved moldability and machinability, enhancement of elasticity, increase in tensile strength, pressure resistance, fatigue strength under reversed bending stresses, torsional strength, decreased moisture absorption, increased longevity and, not least, an environmentally friendly waste disposability nowadays particularly appreciated and hence advantageous, owing to the given biological degradability.

In addition, the products manufactured with the binder and/or building material according to the invention are distinguished by a lower bulk density and an increased flowability. They display drastically a reduced dust formation and reduced electrostatic charging.

The problem is also solved by a method to manufacture a binder or building material on the basis of a synthetic material or inorganic polymer with at least one vegetable oil, vegetable oil constituent, or vegetable oil derivative, in which the synthetic material or inorganic polymer in machined or finely dispersed form is reacted with the vegetable oil, constituent of a vegetable oil, or derivative of a vegetable oil in a first procedure step; and afterwards, in a second step, the synthetic material or polymer thus modified is reacted with the identical or an additional vegetable oil, vegetable oil constituent, or vegetable oil derivative.

With this method according to the invention, the applicant has further developed the discovery already represented in his first application, which still related to an oil-binding agent, in which subsequent to the first procedure step, i.e. coating of the synthetic material with the vegetable oil, only “oil comes to oil”, which constitutes the particular product characteristics of the known oil-binding agent, but also the particular product characteristics of binder obtained by the method according to the invention here presented in its various possibilities of application.

The method according to the invention differs from the production of the known oil-binding agent essentially in that there only the first procedure step was required to manufacture the agent, i.e. the synthetic material such as polystyrene was coated with the vegetable oil and the thus already obtained special and modified properties of the polystyrene yielded the ready-to-use oil-binding agent. The second procedure step proposed and according to invention here, the additional coating with oil, took with respect to the known oil-binding agent only place when it was applied, i.e. upon its practical application.

Accordingly, it was crude oil or an oil pollution which had been bound to the polystyrene modified in accordance with the first procedure step, and not, as is foreseen according to the invention here, another vegetable oil, its constituent or derivative. The binder and/or building material here presented according to the invention based on polystyrene as the synthetic material to be preferably used, or based on an inorganic polymer -, will only be complete and usable in various applications after the execution of the second procedure step.

Due to the differences between the production of the known oil-binding agent and the method to manufacture a binder according to the invention, it was also necessary that a finely dispersed polystyrene and/or finely dispersed synthetic material, or a dispersion of either polystyrene-or the synthetic material, is used rather than a polystyrene fragmented, for example, by machining. The possibilities to use the binder can also be extended when polystyrene is not applied in pure form but, for example, in form of polystyrene copolymerisates with additional polymers. Particularly such copolymerisates that are based on styrene/acrylate are to be mentioned. Preferably finely dispersed polystyrene or polystyrene-copolymerisates are applied in form of dispersions.

The invention is also related to the use of the binder or building material according to the invention as well as the use of the method according to the invention for the manufacturing in the field of detergents and cleaning agents.

In this regard, the application was based-on the observation that the synthetic material, or the polymer, bound to the vegetable oil conglomerates to yield essentially uniformly spherical structures displaying a high degree of stability once further oil is added.

The fact that a genuine chemical compound is created by binding the synthetic material or polymer to the vegetable oil and a particularly high bulk density as well as a particularly good flowability of the obtained product is achieved, can be exploited in a most preferred application which relates to its use in the manufacture of a granulated detergent and cleaning agent.

Properties such as a high bulk density and an improved flowability have always been the objective pursued in the development of non-liquid detergents and cleaning agents, as this enables reduced packaging sizes at a constant or even improved washing efficiency, markedly reducing the transport costs and the weight of detergent packages. The current state of art has been working for some time on the development of granulation methods which result in the formation of essentially uniformly spherical granulates.

The granulated detergent and cleaning agent according to the invention is also associated with an increase of washing power. This is explicable with the formation of an absorptive compound between the other granulate constituents and the vegetable oil derivative as used in form of a lipid alcohol polyglycol ether. As is known relative to the washing power of a detergent, the wetting equilibrium at the sold-liquid interface and hence the wetting tension is of considerable importance. This is strongly modified by the surface-active agent (tenside), since the wetting angle of the dirt on the textile fiber surface is changed.

In principle, owing to the detergent containing the surface-active substance, a decrease in the wetting angle on the fiber surface of the soiled textile occurs on account of the hydrophobic residues of the surface-active substance. Experiments of the applicant now allow the conclusion that the detergent's special granular structure, obtained according to the invention by the absorptive binding with the vegetable oil derivative, considerably enhances the rewetting process which detaches the dirt particles under the dynamic conditions in a washing machine, solubilizes them in the soapy water and thus removes them from the textile.

Silicates, to which zeolites belong, are known as building materials used in detergent manufacturing. In particular, bleaching agents, anionic surface-active substances and, if required, other known additives are included as solid constituents in order to produce the finished detergent. Just like the organic polymer, e.g. polystyrene in case of the adhesives, the inorganic polymer in form of the silicate and/or zeolite, and additionally the other solid constituents mentioned, also serve as carrier materials for the granulates. These are preferably not reacted with a vegetable oil as such in the first procedure step, instead, with a vegetable oil constituent and/or vegetable oil derivative, whereby particularly fatty alcohols and most particularly the ethoxylated fatty alcohols with 8 to 20 carbon atoms, preferably 12 to 18 carbon atoms, are to be mentioned in this regard. They are optionally applied in form of aqueous solutions. In contrary to the manufacturing of adhesives, the concentration of the applied fatty alcohol must be chosen in such a manner that the granulates will be prevented from sticking together.

The fatty alcohols applied may be unsaturated or mixtures of saturated and unsaturated fatty alcohols. In the current state of art methods are known that permit the synthesis of these fatty alcohols. Here, the triglycerides normally contained in the vegetable oils are used, which are subsequently broken down to fatty acids by means of pressure cleavage. One variant even foresees to esterify these fatty acids to yield fatty acid methyl esters. The fatty acid itself, or the fatty acid methyl esters, are then hydrated to yield the respective fatty alcohol.

If the vegetable oil is used as the starting material for the synthesis of the fatty alcohols, the latter will display a high degree of oxidation resistance and essentially no characteristic odor. Starting materials for the fatty alcohol synthesis are, once again, unsaturated or, at least, partially unsaturated vegetable oils such as rape-seed oil, palm oil, coconut oil, sunflower oil, soybean oil, peanut oil, or olive oil.

In the following, the invention is explained in further detail by means of illustrated embodiments accompanied by the drawings.

### BRIEF DESCRIPTION OF THE DRAWINGS

FIG. 1a is a light microscopic shot of a polystyrene granulate coated with rape-seed oil at 10-fold magnification.

FIG. 1b is the same light microscopic shot as in FIG. 1a, but with a 57-fold magnification.

FIG. 2a is a scanning electron microscopy (SEN) shot of a polystyrene granulate particle coated with rape-seed oil at 50-fold magnification.

FIG. 2b is the same shot as in FIG. 2a, but with a 200-fold magnification.

FIG. 3 shows a spherical particle made of polystyrene rigid foam, after crude oil absorption, diameters are indicated in mm.

FIG. 4a is a light microscopic shot of a polystyrene granulate coated with crude oil at 32-fold magnification.

FIG. 4b is the same shot as in FIG. 4a, but with a 57-fold magnification.

FIG. 5a is another light microscopic shot of a polystyrene granulate-coated with crude oil at 32-fold magnification.

FIG. 5b is the same shot as in FIG. 5a, but with a 57-fold magnification.

FIG. 6a is a scanning -electron microscopy (SEN) shot of a cross-section through an agglomeration of a polystyrene granulate coated with crude oil, at magnification 50-fold, and

FIG. 6b is the same shot as in FIG. 6a, but with a 200-fold magnification.

### EXAMPLE 1

The organic polymer used for the purposes of this experiment is a rigid synthetic foam made of polystyrene in form of a polystyrene granulate. This polystyrene granulate is coated with rape-seed oil in such a manner that approximately 5 g oil are calculated to be applied to 100 g of granulate. In the case of this embodiment the oil was sprayed on the granulate. The polystyrene granulate is a granulate commercially available from BASF AG, Germany.

Under high pressure, the granulate is somewhat sticky to the touch after the polystyrene granulate is coated with the rape-seed oil, however, it does not show a special tendency to agglomerate.

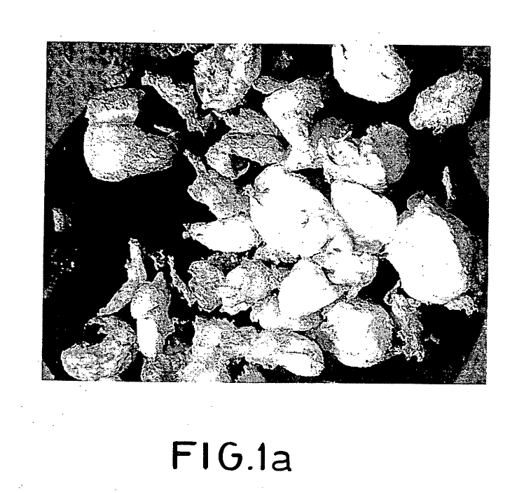

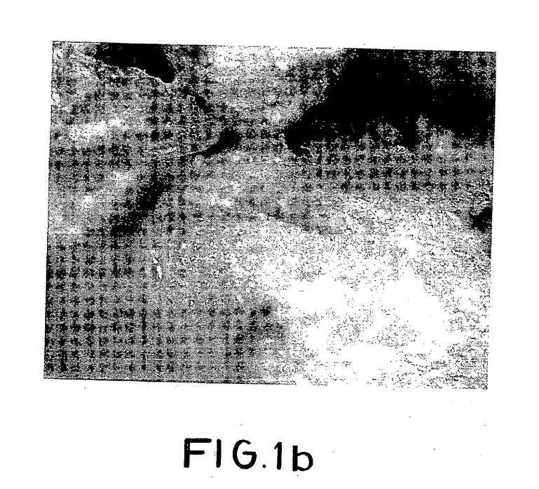

The polystyrene granulate thus coated with-the rape-seed oil has been photographed under a stereo microscope (Olympus SZX 9) at 10-fold magnification and is shown as FIG. 1a. FIG. 1b depicts a detail of the same granulate coated with rape-seed oil, however, with a 57-fold magnification. The rape-seed oil coating is perfectly visible.

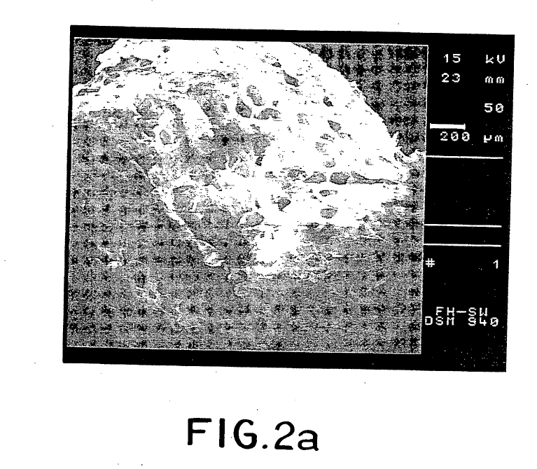

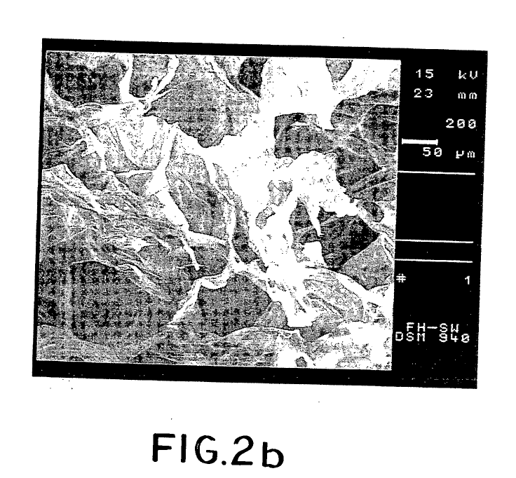

The same shots were additionally performed with a digital electron scanning microscope (Zeiss DSM 940). The results are shown in FIG. 2a with a 50-fold magnification and in FIG. 2b with a 200-fold magnification.

In a simple experimental arrangement consisting of a water-filled glass cylinder measuring 40 cm in diameter and 50 cm in height, a thin layer of crude oil was applied onto the water surface in such a manner that a confluent oil slick was formed. Machined polystyrene foam finely coated with rape-seed oil was then poured onto this surface. Within a short period of time, the crude oil located on the water surface was absorbed in stages by the polystyrene foam coated with rape-seed oil, without the surface being stirred or touched in any form.

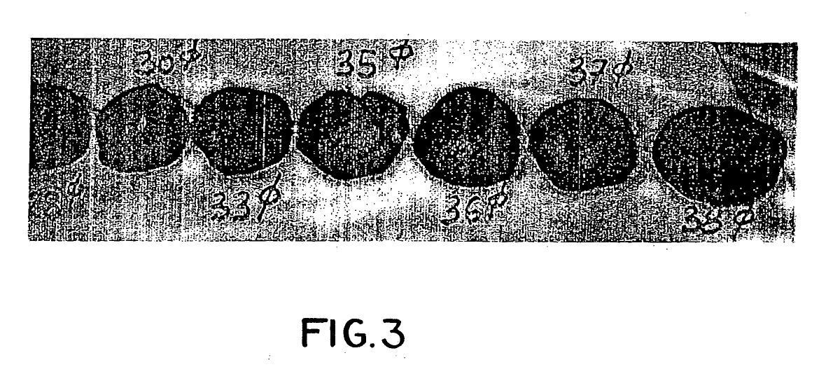

Even amounts of the polystyrene foam which had been deliberately accumulated on the surface were reached by the crude oil. It was astonishing to observe that the crude oil even climbed up into the heaps. Suction forces could be more or less observed. Essentially regularly shaped spherical particles, which assumed a black color owing to the crude oil, were formed when the amounts were selected in certain ratios. The spherical particles thus obtained from the polystyrene foam having absorbed the crude oil are shown in FIG. 3 in more detail.

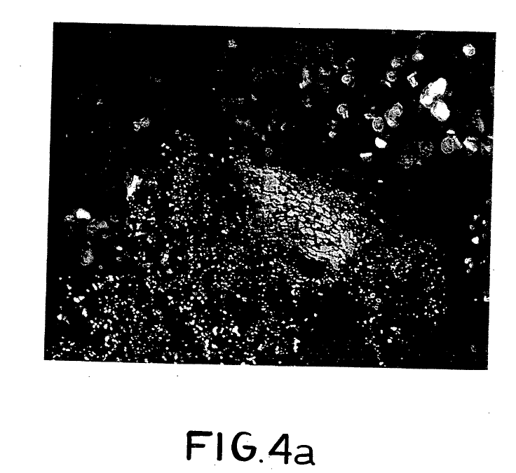

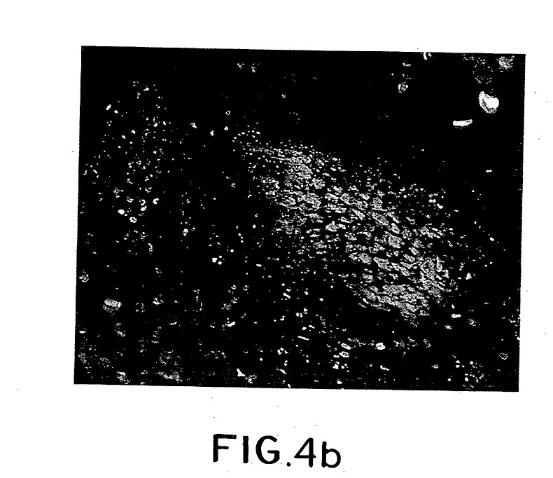

For the purpose of further examination, a thus obtained spherical particle from the rigid polystyrene foam which had absorbed the crude oil was dissected with a razor blade and the cross-section was photographed under an Olympus SZX 9 stereo light-optical microscope. The fine veins of the polystyrene granulate having absorbed the crude oil, and a mass of crude oil perfusing through a centrally dissected granule are distinctly visible in the light-microscopy shot. The shot shows a 32-fold magnification of the object and is presented here as FIG. 4a. In FIG. 4b, the identical cross-section through such a spherical particle is represented as a light-microscopy shot produced with the Olympus SZX 9 stereo microscope, however, in 57-fold magnification, showing the details depicted in FIG. 4a once again somewhat more clearly.

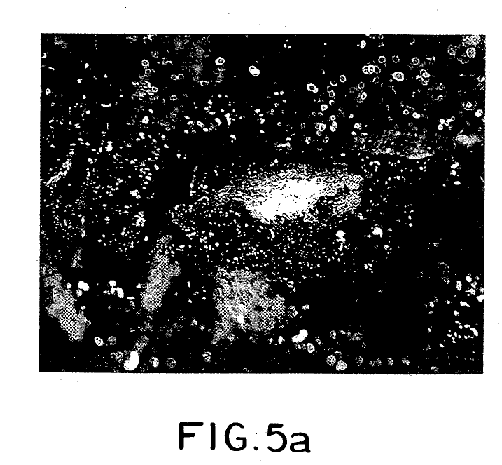

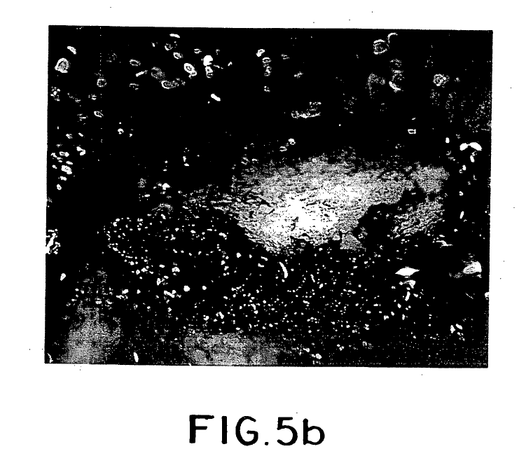

The spherical particle resulting from the absorption of crude oil by the polystyrene coated with rape-seed oil was again dissected at another site, again with a razor blade, in such a manner that a granule situated near the externally visible margin was partially cut. FIG. 5a shows the resulting image obtained with the same light microscope as used previously in 32-fold magnification. In this image, the driving force of the crude oil and its orientation on the granule, comparable with the effect of magnet on filed iron dust, is distinctly visible.

The same shot, however, in 57-fold magnification, is shown in FIG. 5b and reveals the orientation of the crude oil towards the granule once again more distinctly.

The same shots were additionally recorded with a digital scanning electron microscope (Zeiss DSM 940). They serve to provide more information about the surface structure of the crude oil which has arranged itself on the polystyrene granule coated with rape-seed oil, and simultaneously about the association between polystyrene granule and crude oil.

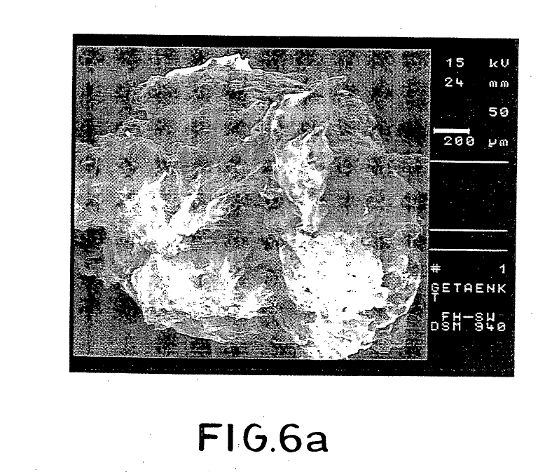

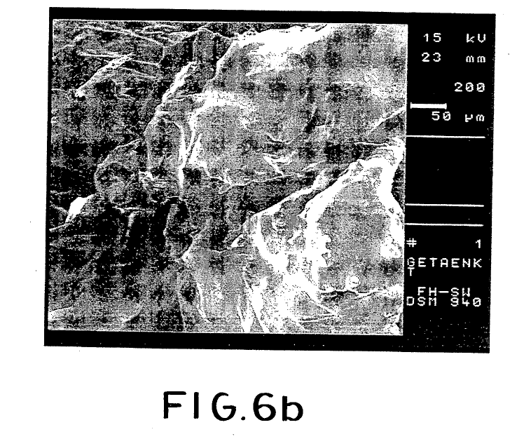

In FIG. 6a, a first scanning electron microscopic shot of the cross-section through the spherical particle shows in 50-fold magnification a granule which is completely surrounded by crude oil. Here, the structural layers of the crude oil are clearly visible. Since the operation voltage of the electron microscope used amounted to 15,000 Volts, the electron beams of the microscope are capable of penetrating the crude oil thus making it appear white instead of black.

FIG. 6b shows the same shot but in 200-fold magnification. Although the thus visible surface detail of the crude oil bound to the granule is smaller, the profile of the crude oil is shown more distinctly.

These scanning electron microscopic shots have not only illustratively depicted more information about the long assumed intimate association between the crude oil and the polystyrene granulate coated with rape-seed oil but permit to draw conclusions on the nature of the association between granulate and crude oil. As is known, scanning electron microscopic shots are only possible when a vacuum is applied into which the sample to be studied is placed. The DSM 940 microscope used here has a magnifying range of 5 to 100000, produced a high vacuum of 10⁻⁴ Torr when the shots were taken. If the binding between the granulate and the crude oil to be adhered and thus bound thereto, was of physical nature only, this binding would not have withstood the effect of the high vacuum. As a result, the crude oil must have become detached from the surface of the granulate and soiled the highly sensitive scanning electron microscope.

Due to the fact that the spherical particles made of rigid polystyrene foam, and/or a part of same, which had been formed by the absorption of crude oil and conveyed into the high vacuum of the scanning electron microscope to study their cross-sections, did not release even a trace of the attached crude oil clearly demonstrates that the connection between the crude oil and the polystyrene granulate is by no means of physical, but has to be of chemical nature. Hence there is a genuine chemical bond between the two components induced by absorption.

Various experiments revealed that due to this absorptive connection between the rigid polystyrene foam, and/or polystyrene granulate, and the oil, and hence due to the application of the oil to the capillary system of the polystyrene present in machined or, in principle, fragmented form—the oil-binding capacity intrinsic to it anyway is enhanced and, particularly, the uptake of moisture and water is prevented. The slight degree of adhesiveness observed already permits to draw conclusions on the capacity of this new product to represent a binding agent. The possible applications, however, are quite various and supposed to be exemplarily presented in the following examples. It has to be noted in this regard that not only the vegetable oil as such is reasonably used in this technical field but in form of its constituents and/or derivatives. The constituents and derivatives applied in the following examples are normally either commercially available products or their synthesis is sufficiently known in the current state of art.

### EXAMPLE 2

### Preparation of an Adhesive

### EXAMPLE 2a

90 weight percentages of an aqueous styrene/butyl acrylate dispersion commercially available from BASF AG, Germany, as Acronal 290 D were stirred under increasing temperature in 10 weight percentages rape-seed oil to yield a homogeneous dispersion, then applied to various surfaces such as wood, plastic, and cardboard and left to dry. The surfaces thus obtained were covered with paper which could not be removed again without tearing it apart.

### EXAMPLE 2b

85 weight percentages of an aqueous styrene/butyl acrylate dispersion commercially available from BASF AG, Germany, as Acronal 290 D were stirred under increasing temperature in 15 weight percentages RME to yield a homogeneous dispersion, then applied to various surfaces such as wood, plastic, and cardboard and left to dry. The surfaces thus obtained were covered with paper which could also not be removed again without tearing it apart.

### EXAMPLE 3

### Preparation of an Additive to Hydraulic Binding Agents

The compositions of the adhesives described further above also serve as the basis of building materials, whereby Acronal 290 D was once again used and tested for the following application purposes:

a) Additive to Mortar Slurries:

The use of the composition according to the invention as an additive to mortar slurries improved the plasticity and processability of the mortar, without increasing the moisture content of the latter.

In addition, an improved structural rigidity, viscosity, adhesion, and improved reaction to forces was determined.

b) Additive to Cement Mortar and Cement Fillers

Here, an increased stability and elasticity and improved bonding properties were obtained. Cracking and abrasion were reduced. The fact that an improvement of corrosion protection was determined in long-term experiments is pointed out as a special feature.

c) Additive to Concrete Floor Pavement and Paving Mortar

Compared to conventional products, thinner reinforced floor pavement layers could be used. Resistance to abrasion and elasticity were increased and the adhesion of the mortar and/or plaster layers onto the smooth subsurface were improved. The adhesive attachment of tiles and natural stone plates was also markedly higher compared to conventional products.

d) Repairs

The compositions according to the invention were also able to be applied without difficulty to repairs of already existing concrete parts, including precast concrete parts, cast plaster floors, and plasters.

### EXAMPLE 4

### Manufacture of a High Bulk Density-Detergent Granulate

The detergent granulate was manufactured on the basis of the following composition, whereby the fundamental composition does not differ from the conventional common detergent formulations in its essentials. The success according to the invention consisting in the formation of a homogeneous granulate, including a high bulk density and an astonishingly good flowability of the product obtained, is also produced when the compositions differ. Various compositions have also been tested. The margins of the amount ratios having been applied in this regard are respectively reported in parentheses.

Composition:

11.0 wt. % [8-12 wt. %] C₉-C₁₃ alkylbenzene

Sulfonate

2.0 wt. % [1-3.5 wt. %] Sebaceous fatty alcohol—7 polyglycol ether

5.0 wt. % [1-5 wt. %] C₁₂-C₁₈ fatty acid soap and silicon oil as foam inhibitors

2,0.0 wt. % [20-30 wt. %] Zeolite A

4.0 wt. % [4-7 wt. %] Polyacrylic acid/maleic acid copolymer
(Sokalan CP 5 from BASG AG, Germany).

15.0 wt. % [12-18 wt. %] Sodium carbonate

16.0 wt. % [10-20 wt. %] Sodium perborate

2.0 wt. % [0.2-2.0 wt. %] Magnesium silicate as stabilizer

3.5 wt. % [2-7 wt. %] Sodium silicate

2.0 wt. % [2-20 wt. %] Sodium sulfate

5.0 wt. % [4-8 wt. %] C₁₂-C₁₈ fatty alcohol-7-polyglycol ether

Additional constituents are water, enzymes (proteases, lipases), optical brightening agents, perfume and, if applicable, colorants and bleaching activators.

The essential difference in the manufacture of the detergent granulate according to invention compared to the conventional procedure consists in the dual-phase product engineering.

First, a preliminary granulate is made in the common and known way, e.g. by spay drying, obtained from alkylbenzene sulfonate as anionic surface-active substance, perborate as bleaching agent, a commercially available zeolite, sodium carbonate and Sokalan as co-building material, sodium silicate, completing agent and water, mixed with the other substances mentioned, and then processed with the additional C₁₂-C₁₈ fatty alcohol-7-polyglycol is ether to yield the finished granulate.

Granulation is terminated once the desired size of granules is reached.

An almost dust-free, homogeneous granulate with high bulk density and high flowability was obtained. Granulation was terminated as soon as a bulk density of 885 g/l was reached.

I claim:

1. A binder or building material on the basis of a synthetic material or an inorganic polymer, available as an absorptive compound from the fragmented synthetic material or inorganic polymer and at least one vegetable oil, vegetable oil constituent or vegetable oil derivative, if necessary, with additional components or additives.

2. The binder or building material as defined in claim 1 wherein the synthetic material is polystyrene in the form of a monopolymerisate or copolymerisate.

3. The binder or building material as defined in claim 1 wherein the synthetic material is selected from a modified polystyrene, preferentially a-methyl styrene.

4. The binder or building material as defined in claim 1 wherein the synthetic material is selected from a styrene/(meth)acrylate copolymer.

5. The binder or building material as defined in claim 1 wherein the synthetic material or the inorganic polymer is a dispersion.

6. The binder or building material as defined in claim 1 wherein the vegetable oil is selected from rape-seed oil, sunflower-seed oil, soybean oil, castor oil, olive oil, linseed oil, coconut oil, palm oil, a constituent or derivative and mixtures thereof.

7. The binder or building material as defined in claim 1 wherein the derivative is an ester.

8. The binder or building material as defined in claim 1 wherein the derivative is a glycerin ester of a multiple-unsaturated fatty acid.

9. Use of the binder or building material obtained as defined in claim 1 as an adhesive or sealant.

10. Use of the binder or building material obtained as defined in claim 1 as an additive to building materials, in particular, hydraulic binding agents, gypsum, non-hydraulic lime and dry mortar products.

11. A method of manufacturing binders or building materials on the basis of a synthetic material or inorganic polymer with at least one vegetable oil, vegetable oil constituent, or vegetable oil derivative, in which the synthetic material or the inorganic polymer in machined or finely dispersed form is left to react with the vegetable oil, constituent of a vegetable oil, or derivative of a vegetable oil in a first procedure step; and afterwards, in a second, the synthetic material or polymer thus modified is left to react with the identical or an additional vegetable oil, vegetable oil constituent, or vegetable oil derivative.

12. Use of the binder or building material obtained as defined in claim 1 to manufacture an essentially homogeneous granulate of high flowability and bulk density.

13. Use of the binder or building material obtained as defined in claim 1 as a constituent of detergents and cleaning agents.

14. Use of the binder or building material obtained as defined in claim 1 as a precursor or intermediate product for cosmetics and body-care products.
